(19) United States
(12) Patent Application Publication
(10) Pub. No.: US 2026/0200602 A1
(43) Pub. Date: Jul. 16, 2026

(54) REFUELING SYSTEM FOR A SPACECRAFT, AND METHOD FOR FILLING A FUEL TANK OF A SPACECRAFT

(71) Applicant: GATE SPACE INNOVATION GMBH, Wien-Flughafen (AT)

(72) Inventor: Alexander SEBO, Wien-Flughafen (AT)

(73) Assignee: GATE SPACE INNOVATION GMBH, Wien-Flughafen (AT)

(21) Appl. No.: 19/136,127

(22) PCT Filed: Dec. 6, 2023
(86) PCT No.: PCT/EP2023/084584

§ 371 Date: Jun. 5, 2025

(30) Foreign Application Priority Data
Dec. 12, 2022 (DE) 10 2022 133 026.5

(51) Int. Cl. B64G 1/40; F17C 5/00

(52) U.S. Cl. CPC B64G 1/4021; B64G 1/401; F17C 5/002; F17C 2205/0332; F17C 2205/0352; F17C 2223/013; F17C 2227/0302; F17C 2227/0337; F17C 2250/043; F17C 2265/065; F17C 2270/0197

(57) ABSTRACT

A refueling system for a space vehicle, comprises
a fuel tank assigned to the space vehicle,
a cooling device assigned to the fuel tank,
a fuel line which is connected to the fuel tank and is provided with a component of a coupling system so that it can be connected to a supply line, a shut-off valve being assigned to the fuel line,
a pressure sensor for detecting the pressure in the fuel tank,
a storage tank containing a liquid fuel,
a heating device assigned to the storage tank,
a supply line which is connected to the storage tank and is provided with another component of the coupling system so that it can be coupled to the fuel line,
a pressure sensor for detecting the pressure in the storage tank, and
a control which is coupled to the pressure sensors and can drive the shut-off valves, the heating device and the cooling device such that a volume flow of fuel from the storage tank to the fuel tank is achieved.

Also disclosed is a method of filling a fuel tank of a space vehicle.

### CROSS-REFERENCE(S) TO RELATED APPLICATION(S)

This application is a United States National Phase of International Application No. PCT/EP2023/084584, filed on Dec. 6, 2023, which claims priority to German Application No. 10 2022 133 026.5, filed on Dec. 12, 2022, the entire disclosures of each of which are disclosed herein in entirety.

### BRIEF SUMMARY

The invention relates to a refueling system for a space vehicle which uses a liquid fuel, and to a method of filling a fuel tank of a space vehicle with a liquid fuel. The space vehicle may be, for example, a satellite or a rocket.

### BACKGROUND OF THE INVENTION

Chemical liquid propulsion systems for space vehicles are based on the reaction of a single fluid (i.e., a monopropellant) or two fluids (in a bi-propellant system) and the subsequent release of gas, which is accelerated through a nozzle to generate thrust.

In view of the necessary reactivity of the components, handling the fuels is one of the most critical steps in preparing the space vehicle for launch. Due to the reactivity and often high toxicity of the fuels, extreme precautions must be taken when handling them and filling tanks with the fuel(s) to prevent accidental release and reaction during handling operations. This results in significant costs for operators.

For most fuel combinations, an inert pressurized gas is used to pressurize the fuel out of the tank and into the supply system by means of which the fuel reaches the nozzle. Usually, fuel is pumped into the appropriate tank both during initial refueling (starting point: there is already some inert gas as a pressurized gas in the fuel tank) and during refueling (starting point: the previously introduced fuel has been almost completely consumed and there is a mixture of fuel and pressurized gas in the tank). A mixture of pressurized gas and fuel is then vented from the tank (if there is no separation of pressurized gas and fuel), or pure pressurized gas is vented (if there is a separation and fuel escape can thus be prevented).

This venting can take place into the immediate environment, resulting in a complete loss of the respective gas (or gas mixture). This usually occurs during refueling on the ground. If the discharged gases contain fuel, the discharged and potentially hazardous gases must be treated (e.g., filtered). Alternatively, the escaping gas can be collected, recompressed, and reused. This is usually carried out during refueling in space to avoid the costly loss of pressurized gas and only makes sense if pure pressurizing agent is discharged. Therefore, when refueling in zero gravity, a method of separating propellant gas and pressurized gas is essential.

Certain fuels do not use an inert gas as a pressurizing agent to pressurize the fuel from the tank, instead, these liquid fuels can be stored as pressure-liquefied liquids and utilize the concept of autogenous pressurization. Examples of liquid fuels are nitrous oxide, ethane, ethylene, propane, and propylene. In general terms, the principle of autogenous pressurization can be used for any saturated liquid which is stored in its liquid-vapor equilibrium-even cryogenic liquids can be stored as pressurized-liquefied liquids at elevated temperatures. When the liquid is heated, the vapor pressure and storage pressure increase. Conversely, the vapor pressure and storage pressure decrease when the liquid is cooled.

If liquid fuel is removed from the tank during operation, the pressure in the tank drops. This immediately causes a small portion of the liquid fuel to vaporize to restore the equilibrium vapor pressure and replace the volume of liquid removed from the tank with the same volume of gas. This vaporization causes a slight drop in temperature due to the cold of evaporation. This pressure drop is slow and almost linear, especially compared to systems pressurized with inert gas. Therefore, pressurization with inert gas is not necessary. Once the liquid fuel has been completely displaced, only saturated gaseous fuel remains in the tank.

The object of the invention is to provide a refueling system for a space vehicle which is characterized by few components and therefore low weight. The object of the invention also consists in providing a method of filling a fuel tank of a space vehicle which is easy to carry out and ensures with minimal effort that no hazardous substances escape into the environment.

### BRIEF DESCRIPTION OF THE INVENTION

To achieve this object, a refueling system for a space vehicle is provided according to the invention, comprising a fuel tank assigned to the space vehicle, a cooling device assigned to the fuel tank, a fuel line which is connected to the fuel tank and is provided with a component of a coupling system so that it can be connected to a supply line, a shut-off valve being assigned to the fuel line, and comprising a pressure sensor for detecting the pressure in the fuel tank, a storage tank containing a liquid fuel, a cooling device assigned to the storage tank, a supply line which is connected to the storage tank and is provided with another component of the coupling system so that it can be coupled to the fuel line, a pressure sensor for detecting the pressure in the storage tank, and a control which is coupled to the pressure sensors and can drive the shut-off valves, the heating device and the cooling device such that a volume flow of fuel from the storage tank to the fuel tank is achieved.

To achieve the aforementioned object, a method of filling a fuel tank of a space vehicle is also provided, which can be carried out in a refueling system of the type mentioned above and comprises the following steps: First, a supply line of a storage tank containing liquid fuel is connected to a fuel line of the fuel tank. Then, the storage tank is heated and the fuel tank is cooled simultaneously so that liquid fuel flows from the storage tank through the supply line and the fuel line into the fuel tank.

The process of thermal liquid transfer does not require phase separation and works with gas phase, liquid phase, and mixed phase. Furthermore, the process does not require the action of gravity or the use of a pump for fuel transfer. The liquid transfer is enabled solely by heating and cooling the tanks. Apart from the shut-off valves and couplings, which can be designed as quick couplings, no moving parts are required, which significantly reduces the overall complexity of the system. This liquid transfer process is completely encapsulated and does not require venting of the fuel or the pressurizing medium or recompression of the pressurizing medium.

However, it is not necessary to equalize the pressures of the two tanks before they are connected to each other. As long as the pressure in the storage tank is higher than in the fuel tank, the shut-off valves can be opened in a controlled manner so that the “overpressure” in the storage tank is equalized by allowing part of the fuel volume to flow into the fuel tank. Only then can the transfer of further fuel volume be initiated by heating the storage tank and cooling the fuel tank.

According to a preferred embodiment of the invention, the pressures in the storage tank and in the fuel tank are equalized before the storage tank is connected to the fuel tank. For this purpose, the refueling system may additionally have a heating device assigned to the fuel tank and/or a cooling device assigned to the storage tank. The heating and/or cooling device can be used to bring the two tanks to the same temperature (more precisely, the fuel contained therein is brought to the same temperature) before they are coupled to each other. When the two tanks are then coupled to each other and are in thermal equilibrium, there is initially no net fuel flow between the two tanks, even if one tank is filled with saturated liquid fuel (in this case the storage tank) and one tank is filled with saturated gaseous fuel (in this case the fuel tank). However, if the storage tank is heated and the fuel tank is cooled, a net transfer mass flow occurs between the two tanks. It is determined by one of the following three mechanisms, which requires only a single connecting line between the two tanks:
1) Liquid transfer: Heating the storage tank slightly increases the pressure in the storage tank, which leads to a mass flow into the fuel tank. The loss of liquid volume must be replaced by gas, the heat supplied is thus used to vaporize part of the liquid fuel. In the fuel tank, the inflow of additional liquid volume theoretically leads to an increase in pressure. To maintain the mass flow, the fuel tank can be cooled and thus part of the existing gas recondensed, thus creating space for the incoming fuel. During this process, the temperature and pressure remain almost constant, as the heat flows are used to vaporize and recondense the liquid fuel in the system. This process allows the entire liquid phase to be transferred to the fuel tank, while only the gaseous phase remains in the storage tank. The liquid and gaseous phases have effectively “swapped positions.”
2) Gaseous transfer: Heating the storage tank causes the vaporization of the liquid phase which flows into the gas tank due to the pressure differential, where it recondenses due to the cooling of the fuel tank. Though less efficient than a mass flow with liquid fuel, the result is the same as in mechanism 1.
3) Two-phase transfer: When a mixture of gas and liquid phases is exchanged between the tanks, the combined effects of liquid and gas transfer also allow complete transfer of the fluids. Here, too, the result is the same.

The use of a heating device on the fuel tank and of a cooling device on the storage tank is also advantageous in that each tank may then be used as a storage tank which supplies fuel to the other tank, which then acts as a fuel tank.

According to one embodiment of the invention, a second fuel tank and a second storage tank are provided. Such a system is used when a bi-propellant system is used as a fuel.

In a bi-propellant system, the components of the coupling system for the two fuel lines can be combined into one assembly and the components of the coupling system for the two supply lines can be combined into one assembly, so that the two supply lines can be connected to the two fuel lines with a single coupling operation.

The components of the coupling system may be a system comprising a socket and plug or a unisex system which can be coupled in either direction.

According to one embodiment of the invention, it is provided that the amount of fuel transferred from the storage tank to the fuel tank is calculated on the basis of the amount of energy expended for heating or cooling. This eliminates the need for a flow meter, which has a beneficial effect on the complexity and weight of the refueling system.

### BRIEF DESCRIPTION OF THE DRAWINGS

The invention is described below with reference to three embodiments which are illustrated in the accompanying drawings and in which:

FIG. 1 schematically shows a refueling system according to a first embodiment used for a monopropellant;

FIG. 2 schematically shows a refueling system according to a second embodiment used for a bi-propellant system; and

FIG. 3 schematically shows a variant embodiment of the system of FIG. 2.

### DETAILED DESCRIPTION OF THE INVENTION

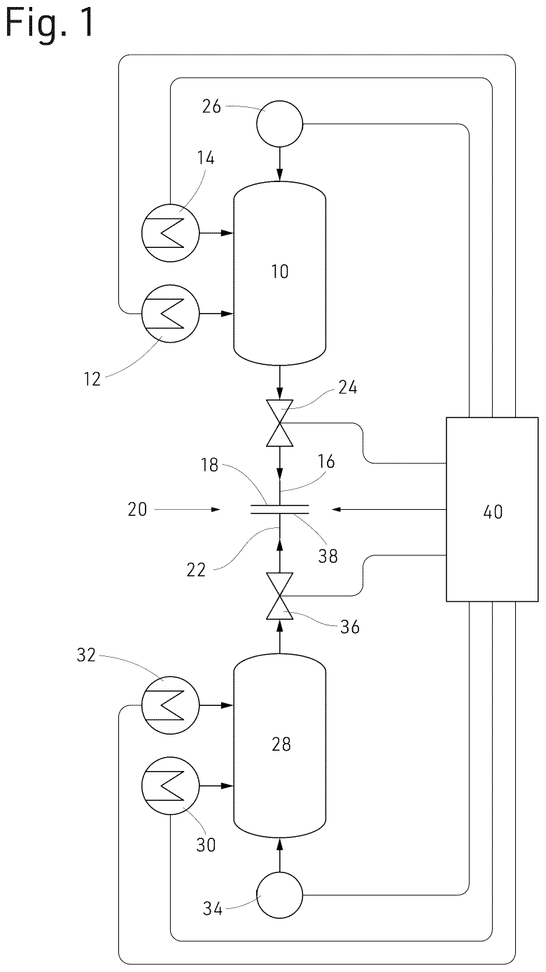

FIG. 1 shows a refueling system for a space vehicle. In particular, the space vehicle may be a satellite. In principle, however, the refueling system can be used to refuel any space vehicle, including a rocket, for example.

On the side of the space vehicle, the refueling system has a fuel tank 10. The fuel tank is intended and configured to store a liquid fuel and deliver it to an engine (not shown here) when needed. The liquid fuel here is a monopropellant.

A cooling device 12 and a heating device 14 are assigned to the fuel tank 10. The cooling device 12 and the heating device 14 enable the contents of the fuel tank 10 to be temperature-controlled. Assuming that at least some fuel is present in the fuel tank 10, the contents of the fuel tank 10 consist of liquid fuel and gaseous fuel, with the two-phase mixture being under a pressure which depends on the temperature (and the vapor pressure of the fuel).

The fuel tank 10 is connected to a fuel line 16. The end facing away from the fuel tank 10 is provided with a component 18 of a coupling system 20. The coupling system 20 serves to connect the fuel line 16 to a supply line 22, which is used to refuel the fuel tank.

The fuel line 16 is provided with a shut-off valve 24, by means of which flow through the fuel line 16 can be enabled or shut off.

The fuel tank 10 is provided with a pressure sensor 26, by means of which the internal pressure of the fuel tank 10 can be detected.

The supply line 22 leads to a storage tank 28, which contains a supply of liquid fuel to be fed to the fuel tank 10. Functionally, the storage tank 28 includes the same components as the fuel tank 10, namely a heating device 30, a cooling device 32, and a pressure sensor 34.

Functionally, the supply line 22 also includes the same components as the fuel line 16, namely a shut-off valve 36 and a component 38 of the coupling system 20.

The components 18, 38 of the coupling system 20 may be a plug on one of the lines which is adapted to be inserted into a socket on the other line. The components 18, 38 may also be parts of a so-called unisex coupling, in which structurally identical components are used on each of the lines so that it is also possible to couple two fuel lines together.

The coupling system 20 is in particular a quick coupling mechanism The shut-off valves 24, 36 may be separately actuated valves, check valves, valves integrated into the quick coupling, or a combination of these valves.

The cooling device 12, 32 and the heating devices 14, 30 can be formed by thermoelectric elements (Peltier elements, etc.), heat pumps (Stirling coolers or other circuits), resistance heaters or heat radiators, which transport heat between the space vehicle and the environment by means of heat radiation.

Finally, the refueling system has a control 40 which receives signals from the two pressure sensors 26, 34 and can drive the two cooling devices 12, 32, the two heating devices 14, 30, and the two shut-off valves 24, 36 (at least insofar as these are not passive check valves).

The control can be assigned to one of the two subsystems (i.e., the storage tank subsystem or the fuel tank subsystem) (i.e., be structurally combined therewith) and drive the components of the other subsystem.

In a first step, the supply line 22 is coupled to the fuel line 16 to supply the fuel tank 10 with fuel.

Then the pressure in the two tanks 10, 28 is equalized. For this purpose, the two tanks are cooled or heated (depending on the pressure respectively present) so that more fuel evaporates or condenses in the corresponding tank.

The step of equalizing the pressure can also be carried out before the two lines 16, 22 are coupled to each other.

In the next step, the two shut-off valves 24, 36 are opened so that a volume flow of fuel can flow between the two tanks 10, 28.

The storage tank 28 is then heated by means of the heating device 30, while at the same time the fuel tank 10 is cooled by means of the cooling device 12. As a result, part of the fuel in the storage tank 28 evaporates, while part of the fuel in the fuel tank 10 condenses. The resulting change in the volume of the gaseous portion of fuel in the corresponding tank (increase in the storage tank 28, decrease in the fuel tank 10) is equalized in that fuel flows from the storage tank 28 into the fuel tank 10 through the supply line 22 and the fuel line 16.

As soon as the desired amount of fuel has been transferred from the storage tank 28 to the fuel tank 10, the shut-off valves 24, 36 are closed and the coupling system 20 is opened so that the supply line 22 is disconnected from the fuel line 18.

The quantity of liquid transferred can be measured using the heating or cooling power supplied to the tanks 10 and 28.

Heating and cooling devices are usually required anyway for tanks which contain pressure-liquefied fuel. In this respect, no additional design work is required.

It is also possible to reverse the roles of the two tanks, i.e., a tank which previously served as a storage tank is filled from a tank which previously served as a fuel tank. The refueling system is particularly versatile in use when a unisex coupling mechanism is used, so that each tank can function as a donor or receiver. This opens up completely new possibilities for fuel management in space.

The thermal transfer method described is also very advantageous for refueling on the ground, as it is completely encapsulated and no fuel or mixture of fuel and pressurized gas leaves the system of interconnected tanks. Therefore, no treatment of the drained fuel and no special safety protocols are necessary.

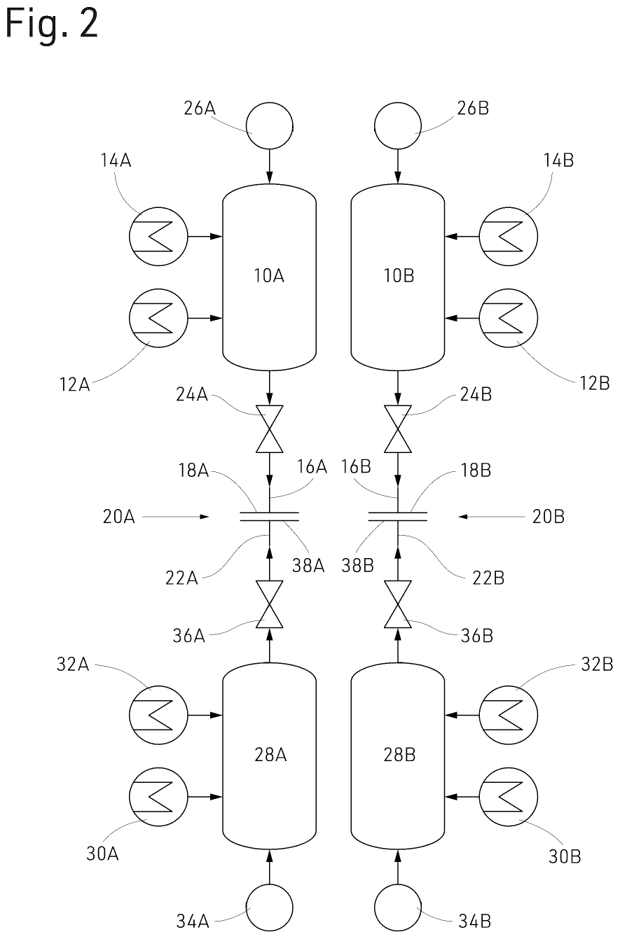

FIG. 2 shows a second embodiment of the refueling system. The same reference numerals are used for the components known from the first embodiment, and in this respect, reference is made to the above explanations.

The difference between the first and the second embodiment is that the fuel used here is a bi-propellant system. Accordingly, all components (except for the control 40) are present in duplicate, i.e., they are provided with reference numeral A for the first liquid fuel and with reference numeral B for the second liquid fuel.

For refueling, the supply line 22A is coupled to the fuel line 16A and the supply line 22B is coupled to the fuel line 16B. The refueling process then takes place in the same way as described for the first embodiment.

For reasons of clarity, the control 40, which is still present, is not shown in FIG. 2. It operates in the same way as in the first embodiment and controls here the components for the two fuel systems.

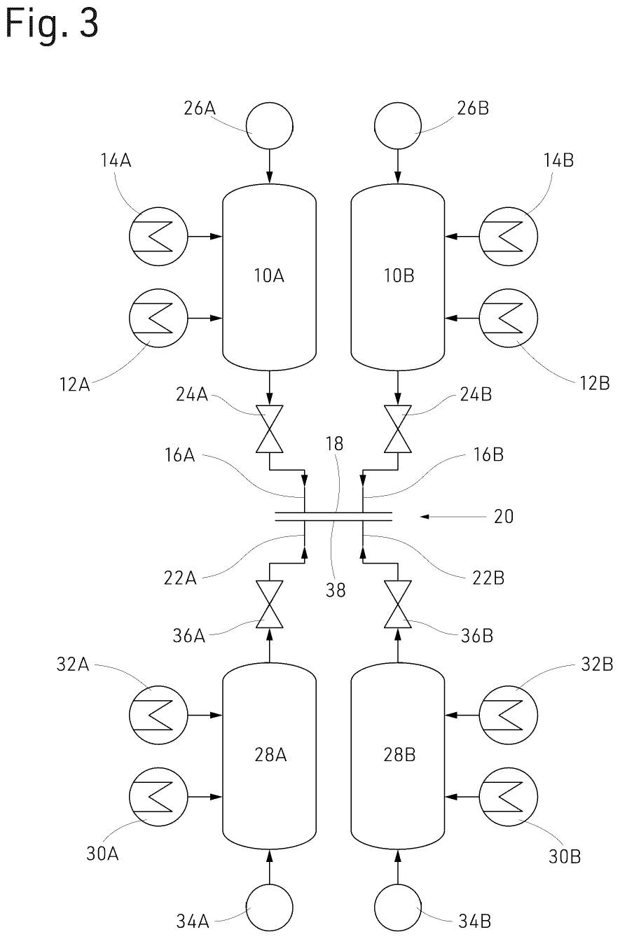

FIG. 3 shows a third embodiment of the refueling system. The same reference numerals are used for the components known from the first and second embodiments, and reference is made to the above explanations as to the first and second embodiments.

The difference between the second and the third embodiment is that, in the third embodiment, the components 18A and 18B on one side of the coupling system 20 and the components 38A and 38B on the other side of the coupling system are each integrated into a single component, so that the two supply lines 22A, 22B do not have to be coupled separately to the two fuel lines 16A, 16B, but rather the two line systems are coupled to each other in a single coupling operation.

The control 40 is not shown, either, in the third embodiment.

In summary, the process according to the invention proceeds as follows:
1. The tanks are brought to the same temperature and thus to the same vapor pressure and connected by means of a single line. Precooling and preheating to create an initial pressure differential can accelerate refueling.
2. The valves are opened, the storage tank is heated, and the fuel tank is cooled. Cooling can be achieved actively (e.g., via Peltier systems) or passively (e.g., by radiating heat into space). The storage tank can be heated actively via heating elements or passively via solar radiation.
3. Heating increases the vapor pressure in the storage tank, while cooling reduces the vapor pressure in the fuel tank. The pressure difference causes the fluid (regardless of the phase thereof) to flow from the storage tank into the fuel tank. The volume freed in the storage tank is refilled by evaporation, and the heat invested for the pressure difference is consumed again. The compressed volume in the fuel tank is compensated by condensation, and the heat thus released compensates for the quantity of heat extracted by cooling. Fluid transfer only takes place when there is a temperature gradient.
4. The connecting valve is closed and the tanks are separated. No fuel is lost during the process and there is no need to vent for the refueling process.

The most important properties are as follows:

The process only works with saturated fluids (gas, vapor, two-phase), but not with supercooled or superheated media
Pressure increase and decrease occur in equilibrium via the vapor pressure
The filling rate is determined by the temperature gradient
Venting of tanks and thus fuel waste is not possible.

1. A refueling system for a space vehicle, comprising
a fuel tank assigned to the space vehicle,
a cooling device assigned to the fuel tank
a fuel line (16; 16A, 16B) which is connected to the fuel tank and is provided with a component of a coupling system so that it can be connected to a supply line, a shut-off valve being assigned to the fuel line,
a pressure sensor for detecting the pressure in the fuel tank,
a storage tank containing a liquid fuel,
a heating device assigned to the storage tank,
a supply line which is connected to the storage tank and is provided with another component of the coupling system so that it can be coupled to the fuel line,
a pressure sensor for detecting the pressure in the storage tank, and
a control which is coupled to the pressure sensors and can drive the shut-off valves, the heating device and the cooling device such that a volume flow of fuel from the storage tank to the fuel tank is achieved.

2. The refueling system of claim 1, wherein a second fuel tank and a second storage tank are provided.

3. The refueling system of claim 2, wherein the components of the coupling system for the two fuel lines are combined into one assembly and the components of the coupling system for the two supply lines are combined into one assembly.

4. The refueling system of claim 1 wherein a heating device is provided which is assigned to the fuel tank

The refueling system of claim 1 wherein a cooling device is provided, which is assigned to the storage tank

6. A method of filling a fuel tank of a space vehicle by means of the following steps, in particular in a refueling system according to claim 1:
a supply line of a storage tank containing liquid fuel is connected to a fuel line of the fuel tank,
the storage tank is heated such that liquid fuel flows from the storage tank through the supply line and the fuel line into the fuel tank while at the same time the fuel tank is cooled during the filling process.

7. The method of claim 6 wherein the pressures in the storage tank and in the fuel tank are equalized before the storage tank is connected to the fuel tank.

8. The method of claim 7 wherein the storage tank and the fuel tank are heated or cooled for the purpose of equalizing the pressures.

9. The method of claim 6 wherein the quantity of fuel transferred from the storage tank into the fuel tank is calculated on the basis of the amount of energy expended for heating or cooling.
